(19) United States
(12) Patent Application Publication
(10) Pub. No.: US 2009/0070137 A1
(43) Pub. Date: Mar. 12, 2009

(54) Method and system to optimize quality of patient care paths

(76) Inventors: Sultan Haider, Erlangen (DE); Klaus Abraham-Fuchs, Erlangen (DE); Volker Schmidt, Moehrendorf (DE); David Wolfgang Eberhard Schmidt, Erlangen (DE); Dominic Pascal Schmidt, Erlangen (DE)

Correspondence Address: BRINKS HOFER GILSON & LIONE, P.O. BOX 10395, CHICAGO, IL, 60610, US

(21) Appl. No.: 11/978,806

(22) Filed: Oct. 29, 2007

Related U.S. Application Data
(60) Provisional application No. 60/993,160, filed on Sep. 10, 2007.

(51) Int. Cl. G06Q 50/00

(52) U.S. Cl. 705/2

(57) ABSTRACT

A system and method for optimizing status of a care plan is described, the method including defining a care plan as worksteps associated by a rule-based process. Historical data is collected for a plurality of worksteps for such attributes as diagnosis, clinical outcome and cost. The data may be analyzed by data mining techniques so as to discover the optimum relationships between the patient symptoms, the worksteps and a success criteria. The success criteria may include correct diagnosis, equipment use efficiency, cost, and successful clinical outcome. The rule-based process may be modified to take account of the optimum relationships. A patient presenting with a constellation of symptoms may have the symptoms compared with care plans success ranking to determine an optimum care plan.

This application claims the benefit of U.S. Provisional application Ser. No. 60/933,160, filed on Sep. 10, 2007, which is incorporated herein by reference.

### TECHNICAL FIELD

The present application relates to a method and system of optimizing patient care by data mining of workflow history.

### BACKGROUND

Conventional medical care plans may be administered to a patient in a series of steps, with individual steps being performed at different medical facilities and/or by different specialists located at dispersed locations. Clinical guidelines may have been established for the diagnosis, treatment and follow up care of a syndrome. The guidelines may be embodied in a care plan comprised of worksteps. However, the optimum selection of the worksteps may be influenced by the availability of personnel and equipment at a medical facility, the health needs and disease patterns of a locality, and the demographics of the patients. As such, an optimum care path for a patient at a specific facility may differ in some respects from a guideline path.

### BRIEF SUMMARY

A method of optimizing a medical care plan is described, the method including describing aspects of a care plan as a plurality of worksteps organized by a rule-based process, analyzing a data base of information relating the performance of a workstep, the performance including at least one of medical diagnosis, cost or outcome; and, modifying the care plan by changing the rule-based process so as to increase a success probability.

A method of improving medical diagnosis includes, compiling a list of symptoms reported by patients; compiling a list of questions asked by medical personnel in response to a symptom or constellation of symptoms; compiling a list of diagnosed medical syndromes; determining a joint likelihood of a specific symptom or constellation of symptoms, the asked questions and the diagnosis; and selecting the symptoms and asked questions having the highest likelihood of resulting in the diagnosis.

A data processing system for optimizing a medical care plan includes a computer operable to maintain a care plan having worksteps, the worksteps being linked by a rule-based process; to collect data from worksteps performed in a clinical environment, the data including at least one of clinical outcome, diagnosis or cost; and, to determine an optimum care plan configuration with respect to at least one of clinical outcome, diagnosis, or cost by analyzing the data using data mining techniques.

A computer-readable medium having instructions executable on a computer stored thereon is described, the instructions causing a computer system to store and maintain a care plan having worksteps, the worksteps being related by a rule process; to accept data input associated with the performance of worksteps characterizing at least one of patient symptoms, cost, clinical outcome, or diagnosis; to analyze the effectiveness of the rule process with respect to at least one of cost, clinical outcome, or diagnosis, based on use of data mining; and to identify modifications of the rule process so as to increase the effectiveness of health care plan.

In an aspect, a constellation of symptoms of a patient is compared with the care paths and a care path chosen so as to maximize a success criteria measure.

A system and method to optimize the quality of medical care is described, including optimizing the clinical workflow steps for a clinical path based on two or more of:

evaluation of patient data generated during the clinical care path;

evaluation of diagnostic questions defined by the medical professional;

evaluation of examination results;

evaluation of clinical, operational and financial parameters;

comparison of the results from the above evaluations against clinical guidelines; or

evaluation of the combination of various process steps within the care paths.

### BRIEF DESCRIPTION OF THE DRAWINGS

FIG. 1 illustrates a table structure for collecting data relating to patient care paths;

FIGS. 2A and 2B are an example of a care path of a patient having an acute cardiovascular infarction;

FIG. 3 is a schematic representation of the association of constellations of patient symptoms with diagnostic questions asked by medical professionals; and

FIG. 4, is a hypothetical data set analyzable to determine the most likely single diagnostic modality associated with a specific set of patient symptoms.

### DETAILED DESCRIPTION

Reference will now be made in detail to embodiments. While the invention will be described in conjunction with these embodiments, it will be understood that it is not intended to limit the invention to such embodiments. In the following description, numerous specific details are set forth in order to provide a thorough understanding of the present invention which, however, may be practiced without some or all of these specific details. In other instances, well known process operations have not been described in detail in order not to unnecessarily obscure the description.

The embodiments described herein include methods, processes, apparatuses, instructions, systems, or business concepts for optimizing the quality of patient care paths. A result of optimizing a care path may be adding, removing or modifying a workstep of the plan.

The combination of hardware and software to accomplish the tasks described herein is termed a system. Where otherwise not specifically defined, acronyms are given their ordinary meaning in the art.

The instructions for implementing processes or methods of the system, may be provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

In an embodiment, the instructions may be stored on a removable media device for reading by local or remote systems. In other embodiments, the instructions may stored in a remote location for transfer through a computer network, a local or wide area network or over telephone lines. In yet other embodiments, the instructions are stored within a given computer or system.

The instructions may be a computer program product, stored or distributed on computer readable media, containing some or all of the instructions to be executed on a computer to perform all or a portion of the method or the operation of the system.

Herein a computer is meant to include, as needed, the central processor unit (CPU), appropriate storage media for data and software, network interfaces, which may include wireless, Internet and LAN, and input and output data terminals, displays, and the like, as is known in the art.

The term “care path”, “clinical care plan” or similar terms as used herein refers to a medical workflow that includes a number of worksteps associated with the diagnosis and/or treatment of an illness. For example, typical worksteps within a care plan may include screening, diagnostic testing, therapy, physical examinations, operations, ambulance care, out-patient care, in-patient care, oncology related care, and other steps. Worksteps may include a sequence of process steps, the use of specified treatment or diagnostic equipment, medical supplies, such as contrast agents, stents, drugs, medical appliances, transportation of the patient, performing medical procedures requiring at least one of non-invasive, minimally invasive or invasive aspects, and the like.

The examples of diseases, syndromes, conditions, and the like, and the types of examination and treatment protocols described herein are by way of example, and are not meant to suggest that the method and system is limited to those named, or the equivalents thereof. As the medical arts are continually advancing, the use of the methods and system described herein may be expected to encompass a broader scope in optimizing the diagnosis and treatment of patients.

A workstep within the care plan may have an associated machine readable form of a written description, graphical depiction, image, table, text, article, flowchart, or other representation or description of the best way of performing the workflow and that may be displayable via the user interface. The term “workstep” is intended to include both the actual process performed and the digital representation thereof.

A graphic, table, or other visual representation may be presentable to the user to display the process steps (such as a graphic depiction of the workstep, along with corresponding textual and/or audio information) of the implemented process and the corresponding clinical guidelines. The sequence of worksteps in a process may be determined on a rule basis, and the each of the rules in the rule basis may have either a deterministic or probabilistic character.

Medical data systems may be used collect information on patients, including medical history, demographic information, results of medical tests, prior treatment, including specific worksteps and outcomes, and other information related to individual patients. Generally, the course of treatment, or care path for a patient is based an electronic formula or other algorithm, with the detailed course of treatment based on the symptoms, tests and patient response to treatment. Each medical facility may have different suites of treatment and diagnostic equipments, and constraints on the use thereof due to scheduling conflicts. The specific staff skills and experience, costs, and clinical outcomes may suggest modifications of the care path, based on the ensemble of patient histories.

The data entered may be used to update, via the computer, a representation of the care plan stored in either a local data base or a remote database accessible over a telecommunications network. Other medical facilities that perform subsequent worksteps within the care plan may then remotely access and locally display the updated representation of the care plan to ascertain the current status of the patient/care plan, such as before performing the next or other subsequent workstep within the care plan.

The system and method may use probabilistic models for optimising the care paths. Patient history data from a plurality of patients may be evaluated using data mining software tools operable on a computer. The data of the actual patient and a variety of possible care paths for an actual patient may then be compared against the data for similar patients in the past. For each possible subprocess in the variety of care paths, the probability that the subprocess leads to new information in the diagnostic process and/or to which this subprocess leads to therapeutic consequences is calculated. An optimum treatment plan may then be chosen based on historical empirical evidence from the data base of workflow data.

From an analytic viewpoint, in another aspect, based on the probability for information gain and/or therapeutic consequence given a particular constellation of symptoms or a particular syndrome, the result of data base mining may suggest modifying a given care path, or choosing an optimal care path from a variety of possible care paths. The system may, for example, suggest adding a workflow step, or eliminating a workflow step from the care path.

An example scenario may be that a large percentage of patients with initial symptoms of breast cancer, which were detected using ultrasound imaging (US), undergo an additional magnetic resonance imaging (MR) examination. The system and method may recognize that the results from both systems correlate to a very high degree, and that one of the imaging modality examinations may be eliminated from the care process, since little additional information is gained by this examination. This could be considered as an optimization of a care plan from a cost-benefit viewpoint.

As advanced methods for self-learning and prediction, the system could use artificial neural networks, genetic algorithms, Bayesian methods, estimation theory, fuzzy logic, or the like. The system may learn about the user preferences for performing certain examination procedures and may optimize the user interface accordingly. The system may offer default protocols for performing examinations according to optimized care paths.

The present embodiments may provide a system/software application operable to present a complete overview of a patient's care path that is to be performed among a number of healthcare institutions and/or specialists, or at a single institution. The software application may include a user interface that implements access rights or other security measures. The user interface may provide user management of one facility with access to data associated with the care plan collected at other facilities.

Statistical evaluation of the medical data associated with one or more worksteps and/or care plans performed on a number of patients may be calculated via a computer.

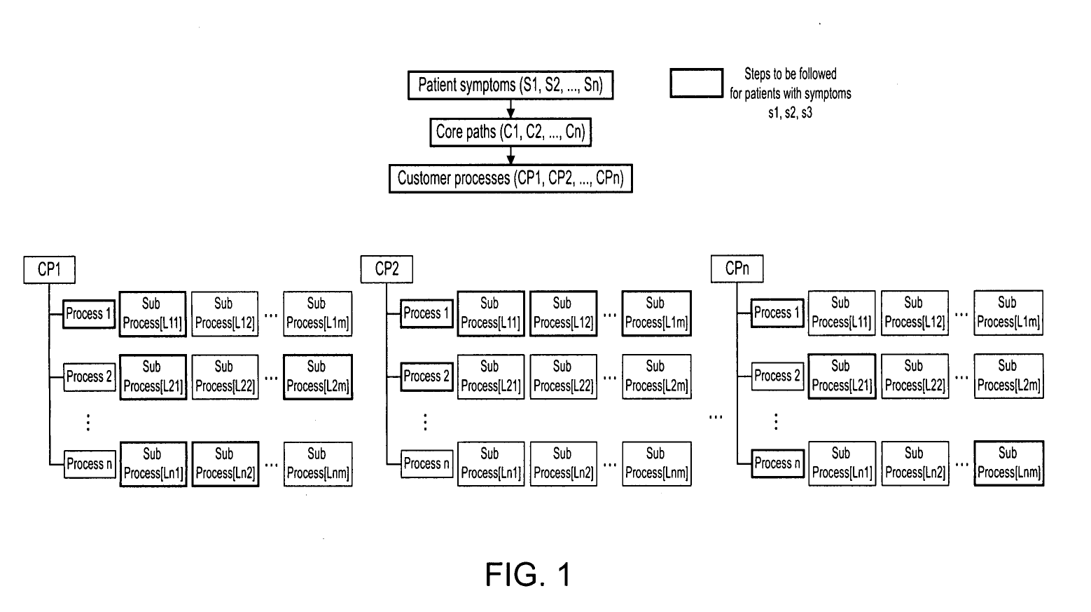

The functioning of the system and method may be understood with respect to the workflows in treatment of a patient. As illustrated in FIG. 1, a patient may present with a combination of symptoms (S1, S2, S3). Based on these symptoms, the patient may be processed along a variety of alternative care paths (C1, C2, C3). For example, care path C1 may involve an office visit, performing routine laboratory tests, and prescribing medication; care path C2 may direct the patient initially to the emergency room; and; care path C3 may involve admission to the hospital for diagnosis or treatment. Each of the care paths Cn may include sequences of processes CP1, CP2, CP3 which may be dependent the results of a previous process. In an example, CP1 may represent the steps in admission of a patient to a hospital, where the case is not an emergency, and the patient is referred to the hospital by a physician.

The chain of subprocesses constitute a clinical work flow as implemented by the healthcare provider. The patient undergoes various processes and sub processes (e.g., admission, diagnosis, therapy, care) within the heath care provider processes CP1, CP2 . . . Cn.

A log file, in which the patient history while undergoing the care path is documented, contains data and information which are called attributes (S1, S2, S3) of the patient history within each care path (C1, C2, C3). Such a log file may be structured e.g. in the following formal way:

```
    CP1(Process1) SubProcess[L1] SubProcess[L21] SubProcess[L2m];
    CP2(Process1) SubProcess[L11] SubProcess[L12] SubProcess[L1m]
(Process2);
    ....
    CPn(Process1) SubProcess[L12] (Process n) SubProcess[Lnm].
```

In addition, the log file may include the result data (diagnostic data and clinical findings, therapeutic consequences, and the like.)

In an embodiment, the clinical workflow may specify, for example, patient and client processes along with resource lists of human, technical and infrastructure resources, information on worker shifts, costs of defined resources, capacities for the resources, interferences between the workflow steps, and resources at the specific healthcare facility.

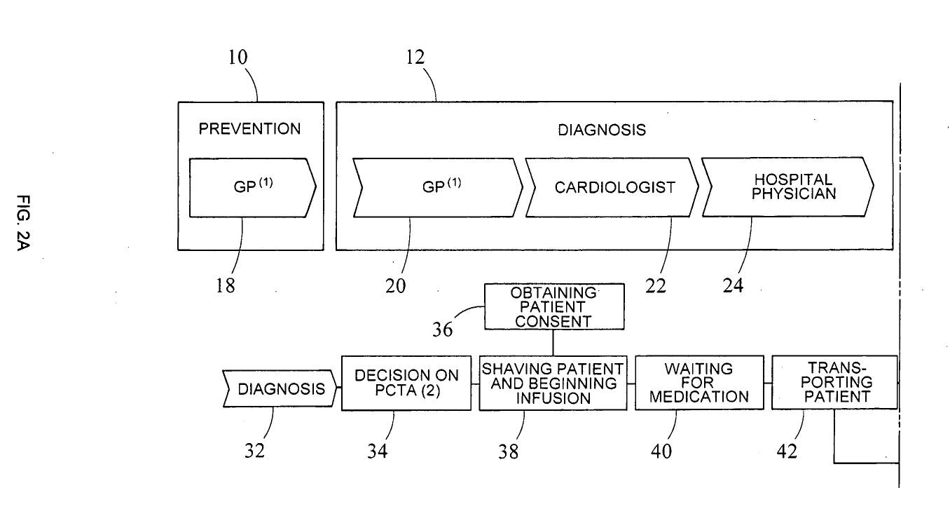

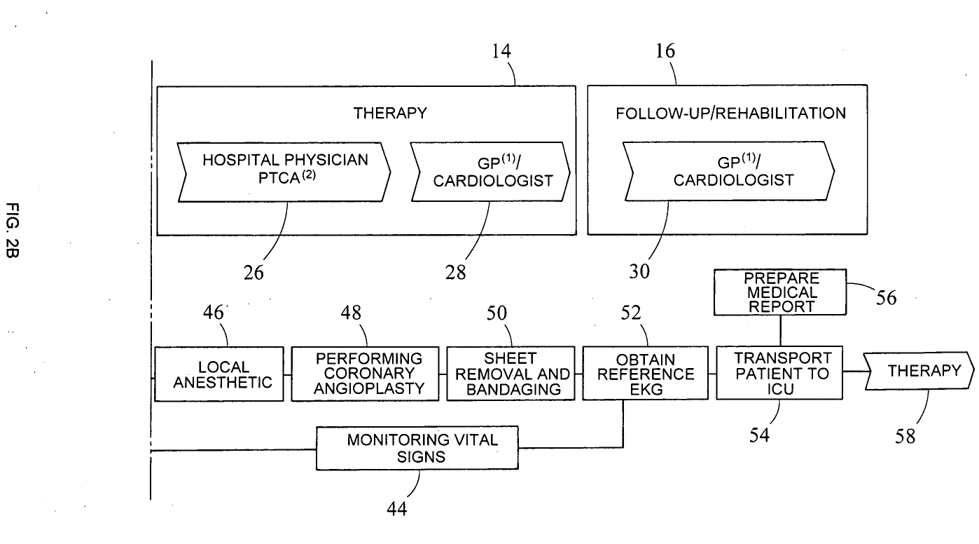

A clinical workflow shown in FIG. 2 may illustrate the workflow processes at a healthcare facility for a patient with acute myocardial infarction (AMI) who is to be treated by percutaneous transluminal coronary angioplasty (PTCA). The upper portion of the illustration shows the major process including prevention 10, diagnosis 12, therapy 14, and follow-up and rehabilitation 16. The personnel who oversee processing in each major step are indicated in each step block. For instance, the prevention stage 10 is carried out under the authority of the general practitioner, indicated as GP. The diagnosis step 12 begins with the GP at step 20; consultation is carried out with a cardiologist at step 22 and then the matter is referred to a hospital physician at step 24. The therapy step 14 is initiated by the hospital physician who carries out the PCTA and, following the PCTA procedure, the patient responsibility is transferred to the general practitioner or cardiologist or at least consultation is carried out with these doctors at step 28. The follow-up and rehabilitation step 16 is the responsibility of the general practitioner and cardiologist at step 30.

The illustrated steps include workflow process steps for each of the steps in the main process stages. For example, the therapy step 14 by the hospital physician who performs the angioplasty includes the steps indicated in the lower portion of FIG. 2, where the therapy stage is begun with diagnosis step 32, followed by a decision to perform the percutaneous transluminal coronary angioplasty (PCTA) at step 34. This is followed by providing information to the patient and obtaining patient consent at step 36 and installation of an intravenous line, shaving the patient and beginning infusion at step 38. Thereafter, a step of waiting and pre-medication 40 is an element to be considered in the process. The patient is then transported to the cathlab (catheter laboratory) at step 42. At this time, there may be continuous monitoring of vital signs as indicated at step 44. Once in the cathlab, a local anesthesia may be applied at step 46, and the percutaneous transluminal coronary angioplasty is performed at step 48. Following the angioplasty procedure, the operating sheets or drapes are removed and the patient is bandaged at step 50. A reference EKG (electro-cardiogram) is then taken at step 52. Following the EKG, the vital signs monitoring step 44 is discontinued. The conclusion of this stage of the therapy includes the transportation of the patient to the intensive care unit (ICU) at step 54 and preparation of a medical report at step 56. The therapy then continues as indicated at step 58.

One of the objectives of the care path in the case of myocardial infarction is to identify the need for a PCTA and perform the procedures as quickly as possible. As such, one of the attributes that would be of interest in valuating the quality of the current care plan is whether the sequence of worksteps leads to the most rapid diagnosis and treatment of the syndrome. This could be measured as time to diagnosis, probability of correct diagnosis, clinical outcome, and the like.

The workstep data of the care plan may be compared against a benchmark care plan; for example, an established clinical guideline of workflow, or historical process data from patients with a similar case histories, and process optimizations may be proposed such that benchmark process or best practice cases are matched most closely.

If the log file includes clinical result data (such as clinical findings, interpretation of diagnostic images, lab data etc.), these may be included in the rules based system for the estimation of the success probability of the process steps

If the log file includes outcomes data (such as cost of a treatment, survival times, hospital stay duration etc), these may also be included in the rule based decision support system. Since outcomes may be an important success measure in clinical workflow, such a rule-based system including historical outcomes data is useful.

In an aspect, the system and method may include using a rule-based engine, a care path implementation system, a databank, and data input and output mechanisms. The care path may be implemented and programmed in an electronic formula or other algorithm. The fields in the formula may be linked to a database, either remotely or locally located, such as a Microsoft SQL-database with a SQL (Structured Query Language) server. Other databases may be used. The system may be operable to add, delete, and/or select data (such as text and/or images) from data files. The system may offer a search mechanism, such as a search engine, operable to search the databases. For instance, medical personnel at one facility may be able to remotely search a database stored at another facility involved with the performance of the care plan to gather information about the care plan, worksteps within the care plan previously or yet to be performed, and other information regarding the patient, including patient characteristics and other healthcare data provided to the patient unrelated to the care plan (such as medications previously or currently prescribed for the patient and past illnesses treated).

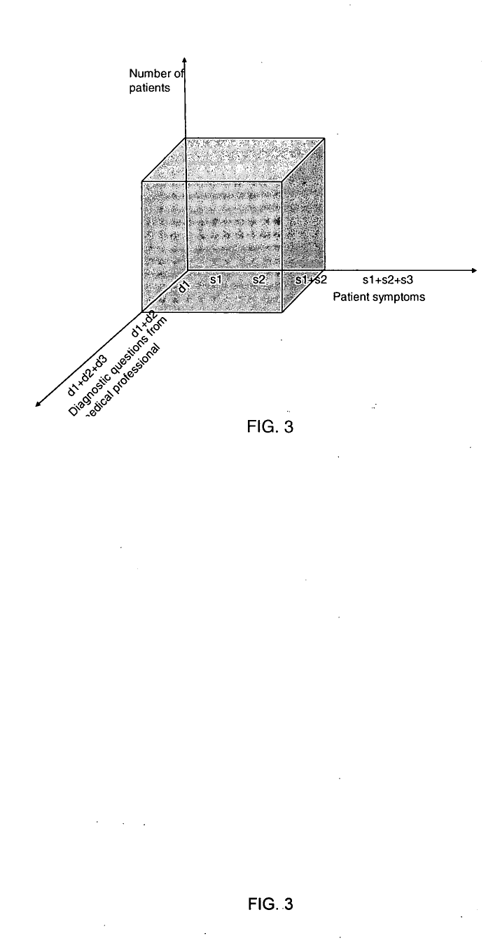

For example, as shown in a simplified form in FIG. 3, the various symptoms S that may be exhibited by a patient, and the combinations thereof, may be analyzed in conjunction with the specific diagnostic questions asked by medical professionals. The number of combinations that result may be very large, and difficult to manually analyze. However data base mining techniques permit the calculation of the degree of association of specific constellations of symptoms with constellations of asked questions and possible diagnoses and outcomes. Such associations may be used to modify the processes of the work steps to suggest the appropriate questions to be asked, or the specific diagnostic tests to be most advantageously used to diagnose a specific syndrome.

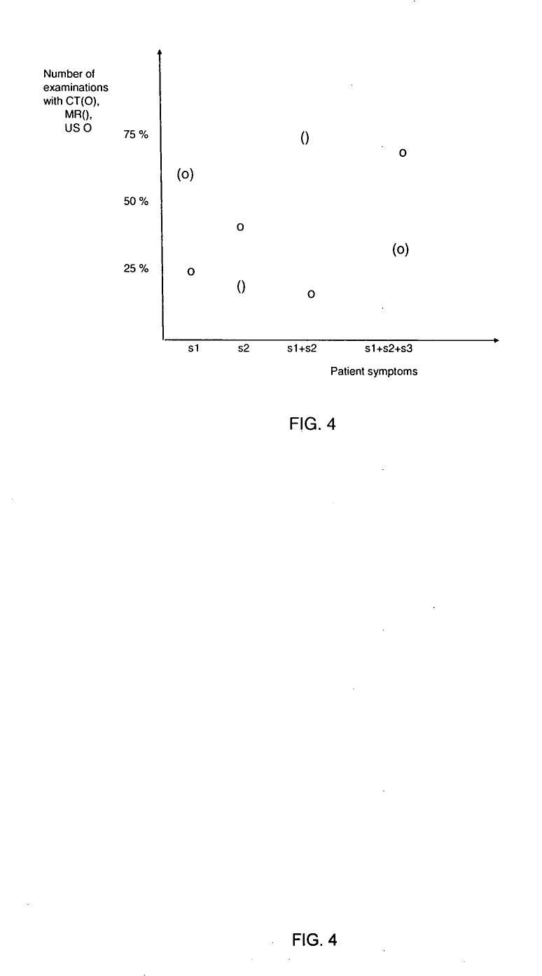

In an aspect, the constellation of symptoms S may be associated with the probability of a specific type of examination being performed. FIG. 4 shows schematically that a relationship may exist between a specific constellation of patient symptoms S, (e.g., S1+S2) and the probability that a particular set of diagnostic studies was performed (e.g., d1+d2). For example, the association of potentially alternative imaging modalities such as, computed tomography (CT), magnetic resonance (MR) and ultrasound (US), with a particular set of patient symptoms may be ascertained. This may further be evaluated to determine the relative outcome success (including time to diagnosis, for example), and the operating cost.

As shown, each of the symptom constellations may be associated with three possible imaging modalities; however, there are circumstances when more than three modalities could have been used. In this example, the analyst may be attempting to associate the specific symptoms with the use of a single best imaging modality for either confirming or ruling out a specific diagnosis. So, a further analysis may be made using data mining to associate each of the imaging modalities the ultimate diagnosis or outcome. In some instances this may lead to a suggested change in the generic care plan for a particular symptom constellation.

Proprietary data base mining tools are available, an example of which is Panoratio (available from Panoratio, Inc., San Francisco, Calif.). “Data Mining” is a term known in the art as the ability to describe, predict, segment, affinity analyze, optimize and discover patterns in large data sets. Relational Databases and OLAP (on-line analytic processing) technologies usually are stored in large disk memories, groups of disk memories known as data centers, or the like. Queries to the data base often result in access to information stored on the disk. In distributed data environments, this disk access may also take place through a network.

The Panoratio software, which is an example of the capabilities of a recently developed specific approach to data mining, losslessly compresses database and, generates a data-dense image of the entire dataset in a proprietary file format, which may be small enough to be resident in computer main memory. This permits a sequence of queries to be formulated by an analyst to better define the data relationships with reduced data processing time.

Optimizing the care plans may be accomplished employing one or more interactive software applications used by customer personnel at various customer locations. The care plans and associated software applications may assist medical personnel located at hospitals and other medical facilities to diagnose and treat patients.

A specific example of a care plan and an analysis of the data associated with the work flows thereof has been described; however, the dimensions of the optimization are not limited thereto. Rather, the data base of medical, cost, organizational and other data associated with the various care plans may be analyzed to optimize the statistical performance on the basis of a variety of relevant measures, such as two or more of, for example:

patient data generated during the clinical care path;

diagnostic questions defined by the medical professional;

examination results;

the patient's position in the care path;

clinical, operational and financial parameters;

comparison of the results from the above evaluations against clinical guidelines; and

evaluation of the combination of various process steps within the care paths.

The methods disclosed herein have been described and shown with reference to particular steps performed in a particular order; however, it will be understood that these steps may be combined, sub-divided, or reordered to from an equivalent method without departing from the teachings of the present invention. Accordingly, unless specifically indicated herein, the order and grouping of steps is not a limitation of the present invention.

While the preferred embodiments of the invention have been described, it should be understood that the invention is not so limited and modifications may be made without departing from the invention. The scope of the invention is defined by the appended claims, and all systems and methods and products that come within the meaning of the claims, either literally or by equivalence, are intended to be embraced therein.

What is claimed is:

1. A method of optimizing a medical care plan, the method comprising:
describing aspects of a care plan as a plurality of worksteps organized by a rule-based process;
analyzing a data base of information relating to a success probability measure of a care plan, the probability including at least one of medical diagnosis, cost, or outcome;
modifying the care plan by changing the rule-based process so as to increase the success probability measure.

2. The method of claim 1, wherein the step of analyzing includes data base mining.

3. The method of claim 1, wherein the rule-based process includes of deterministic associations between the worksteps in the care plan.

4. The method of claim 1, wherein the rule-based process includes probabilistic associations between the worksteps in the care plan.

5. The method of claim 1, where the rule-based process may be modified such that one or more of the worksteps is removed from the rule-based process, or one or more new worksteps are included in the rule-based process.

6. A method of improving medical diagnosis, the method including:
compiling a list of symptoms reported by patients;
compiling a list of questions asked by medical personnel in response to a symptom or constellation of symptoms;
compiling a list of diagnosed medical syndromes;
determining a joint likelihood of a specific symptom or constellation of symptoms, the asked questions and the diagnosis; and
selecting the symptoms and asked questions having the highest likelihood of resulting in the diagnosis,
wherein the data base of symptoms, asked questions and diagnosis is analyzed by data mining.

7. The method of claim 6, wherein the asked questions include diagnostic tests or medical investigations.

8. The method of claim 7, wherein the diagnostic tests include laboratory analysis.

9. The method of claim 6, wherein the cost of each asked question is recorded, and a total cost is associated with each diagnosis.

10. A data processing system for optimizing a medical care plan, the system comprising:
a computer executing a software program product operable to:
maintain a care plan having worksteps, the worksteps being
linked by a rule-based process;
accept data from worksteps performed in a clinical care path, the data including at least one of clinical outcome, diagnosis, or cost;
determine an optimum care plan configuration with respect to at least one of clinical outcome, diagnosis or cost by analyzing the data using data mining techniques.

11. A computer-readable medium having instructions executable on a computer stored thereon, the instructions causing a computer system to:
store and maintain a care plan having worksteps, the worksteps being related by a rule-based process;
accept data input associated with the performance of worksteps including at least one of patient symptoms, cost, clinical outcome, or diagnosis;
analyze the effectiveness of the rule-based process with respect to at least one of cost, clinical outcome, or diagnosis, based on use of data mining; and
identify modifications of the rule-based process so as to increase the effectiveness of he care plan.

12. The computer readable medium of claim 11, wherein:
a symptom or constellation of symptoms of a patient is compared with the care paths and a care path chosen so as to maximize a success criteria measure.

13. The computer readable medium of claim 12, wherein the success criteria measure at least one of probability of correct diagnosis, minimum cost, or successful outcome.
